(19) United States
(12) Patent Application Publication
(10) Pub. No.: US 2011/0140853 A1
(43) Pub. Date: Jun. 16, 2011

(54) RFID READER AND SIGNAL RECEIVING METHOD THEREOF

(75) Inventors: Jae Young JUNG, Daejeon (KR); Dong Beom Shin, Daejeon (KR); Sang Yeoun Lee, Daejeon (KR); Gil Young Choi, Daejeon (KR); Heyung Sub Lee, Daejeon (KR); Jong Suk Chae, Daejeon (KR)

(73) Assignee: ELECTRONICS AND TELECOMMUNICATIONS RESEARCH INSTITUTE, Daejeon (KR)

(21) Appl. No.: 12/819,345

(22) Filed: Jun. 21, 2010

(30) Foreign Application Priority Data
Dec. 15, 2009 (KR) 10-2009-0124978

(51) Int. Cl. H04Q 5/22

(52) U.S. Cl. 340/10.1

(57) ABSTRACT

The present invention relates to an RFID reader and a signal receiving method thereof. The RFID reader according to one embodiment of the present invention down-converts transmission leakage signals introduced into a reader receiver and then suppresses them through a band stop filter in a low frequency band and up-converts them, thereby making it possible to effectively suppress the transmission leakage signals.

### CROSS-REFERENCE TO RELATED APPLICATIONS

This application claims priority under 35 U.S.C. §119 to Korean Patent Application No. 10-2009-0124978, filed on Dec. 15, 2009, in the Korean Intellectual Property Office, the disclosure of which is incorporated herein by reference in its entirety.

### BACKGROUND OF THE INVENTION

1. Field of the Invention

The present invention relates to a radio frequency identification (RFID) reader capable of suppressing transmission leakage signals, including a band stop filter and a signal receiving method thereof.

2. Description of the Related Art

Generally, an RFID technology provides services such as positioning, remote processing, and managing of objects, information exchange between objects, etc., by attaching tags to each object, wirelessly recognizing unique identifiers (IDs) of objects, and collecting, storing, processing, and tracking the corresponding information on the objects. The RFID technology is forecasted to form a new market by replacing the existing barcode and being applied to various fields such as materials management, distribution, security, and so on.

A 900 MHz UHF RFID system is a passive type and a data transmission scheme thereof uses backscattering modulation. The backscattering modulation is a method that transmits information on tags by changing the magnitude of scattered electromagnetic waves when the tags scatter continuous waves (CWs) sent from the reader and returns them to the reader.

A 900 MHz UHF RFID system according to the related art will be described with reference to FIG. 1. FIG. 1 is a configuration diagram of a general 900 MHz RFID system according to the related art.

Referring to FIG. 1, the 900 MHz UHF RFID system includes an RFID reader 100 and a tag 200. The RFID reader 100 includes a reader transmitter RTx, a reader receiver RRx, and a modulation/demodulation frequency generator 115.

The reader transmitter RTx includes a digital-to-analog converter 101 that converts reader command signals which are digital signals into analog signals, a low pass filter 102, a modulator 103 that up-converts the converted analog signals into radio frequency signals, a driving amplifier 104 that increases gains in order to supply sufficient energy to the tag, a power amplifier 105, a band pass filter 106, and a transmitting antenna 107.

The reader receiver RRx includes a receiving antenna 108, a band pass filter 109 that suppresses noise of backscattered signals received from the tag 200, a low noise amplifier 110, a demodulator 111 that converts the received backscattered signals into baseband signals, a baseband filter 112, a baseband amplifier 113, and an analog-to-digital converter 114 that converts analog signals into digital signals.

The modulation/demodulation frequency generator 115 generates frequencies input to each of the modulator 103 and the demodulator 111.

According to the communication protocol of the passive RFID system, when the reader transmitter RTx receives the baseband signals from a digital unit, for example, a modem, it alternately transmits the modulation signals and the continuous wave signals. When the reader transmitter RTx transmits the modulation signals, the tag 200 receives only the modulation signals but does not transmit backscattered signals with the modulation signals, such that the reader receiver does not receive signals. On the other hand, when the reader transmitter RTx transmits the continuous waves, the tag 200 transmits backscattered signals, such that the reader receiver RRx receives and processes the backscattered signals.

The tag 200 absorbs a part of the continuous waves from the reader 100 and reflects a part thereof. The reflected signals are the backscattered signals from the tag 200. At this time, the tag information can be carried by changing the reflectivity. The reader 100 can receive the continuous waves while transmitting them. Therefore, the reader 100 uses the same frequency for the transmission and reception. The foregoing communication scheme does not use an FDD scheme or a switch using scheme but instead uses a separate transmitting and receiving antenna or an integrated transmitting and receiving antenna using a circulator or a directional coupler, in order to secure isolation between the transmitter and receiver.

In order to obtain the isolation between the transmitter and receiver, the separate-type transmitting and receiving antenna uses each of the transmitting and receiving antennas 107 and 108, but does not allow for desired space between the transmitting and receiving antennas 107 and 108 due to the response characteristics of the tag 200. Therefore, the isolation between the transmitter and receiver is deteriorated by the signal coupling within the space. In addition, the change in the antenna pattern occurs according to the ambient environment of the antenna and the change in the antenna pattern leads to the coupling of the transmission and reception signals, such that it is difficult to maintain the desired isolation. In particular, it is a disadvantage in that the size of the RFID system becomes large due to the use of two antennas.

The integrated-type transmitting and receiving antenna using the circulator or the directional coupler has a structure capable of receiving the tag information while supplying energy to the tag, such that the transmission signals are transmitted only to the direction of the integrated-type transmitting, and receiving antenna through the circulator or the directional coupler.

However, the isolation between the transmitter and receiver is not generally large in the circulator or the directional coupler, such that a part of the transmission signals is leaked and introduced in the direction of the reader receiver. As a result, the reader receiver simultaneously receives the transmission leakage signals leaked from the reader transmitter and the backscattered signals from the tag. Therefore, there is a problem in that the reader receiver is difficult to recover only the modulation signal components including the tag information among the backscattered signals from the tag.

### SUMMARY OF THE INVENTION

The present invention is to solve the above problems. It is an object of the present invention to provide an RFID reader capable of suppressing transmission leakage current and a signal receiving method thereof.

The present invention is not limited to the above-mentioned object and other objects, which are not described above, can be obviously understood to those skilled in the art from the following description.

According to an exemplary embodiment of the present invention, an RFID reader includes: a reader transmitter that transmits transmission signals; and a reader receiver that down-converts backscattered signals of a tag in a first frequency band corresponding to the transmission signals and the transmission leakage signals leaked from the transmission signals in the first frequency band into a second frequency band lower than the first frequency band and selectively up-converts modulation components including tag information among the backscattered signals from the down-converted results into a third frequency band higher than the second frequency band.

According to another exemplary embodiment of the present invention, a signal receiving method of an RFID reader includes: receiving backscattered signals of a tag in a first frequency band corresponding to transmission signals and transmission leakage signals leaked from the transmission signals in the first frequency band; down-converting the backscattered signals and the transmission leakage signals from the first frequency band into a second frequency band lower than the first frequency band; and selectively up-converting modulation components including tag information among the backscattered signals from the down-converted results into a third frequency band higher than the second frequency band.

According to another exemplary embodiment of the present invention, an RFID reader includes: a down frequency mixer that down-converts backscattered signals of a tag in a first frequency band for transmission signals and transmission leakage signals leaked from the transmission signals in the first frequency band into a second frequency band lower than the first frequency band, a band stop filter that suppresses the transmission leakage signals of the down-converted backscattered signals and transmission leakage signals; and an up frequency mixer that up-converts signals input from the band stop filter into a third frequency band higher than the second frequency band.

The details of other exemplary embodiments are included in the detailed description and the drawings.

According to the exemplary embodiments of the present invention, the RFID reader includes the band stop filter with good frequency selection characteristic quality added to the existing RFID reader receiver to suppress the transmission leakage signals and extract only the modulation components including the tag information among the backscattered signals from the tag, thereby making it possible to improve the recognition distance and recognition rate of the reader.

In particular, the quartz oscillator used in the band stop filter is used in the down conversion and up conversion of the frequency band, such that frequency synchronization is facilitated and a separate frequency generator for up/down conversion of frequency is not needed.

In addition, in the general RFID system, the phase of the reader transmission leakage signal changes every moment according to the radio environment, such that it is difficult for the RFID system to control the phase at all times; however, in the present invention, the band stop filter suppresses the transmission leakage signals in the same circuit, such that the RFID system is not affected by the change in the phase, thereby making it possible to optimally suppress the transmission leakage signals.

### BRIEF DESCRIPTION OF THE DRAWINGS

FIG. 1 is a configuration diagram of a general 900 MHz RFID system according to the related art;

FIG. 2 is a block diagram showing a configuration of an RFID reader according to an exemplary embodiment of the present invention;

FIG. 3 is a conceptual diagram for explaining an operation of the RFID reader according to the exemplary embodiment of the present invention;

FIG. 4 is a flow chart showing a signal receiving method of the RFID reader according to the exemplary embodiment of the present invention;

FIG. 5 is an exemplary circuit diagram of a quartz oscillator shown in FIG. 2; and

FIG. 6 is a graph showing characteristics of a band stop filter shown in FIG. 2.

### DETAILED DESCRIPTION OF THE PREFERRED EMBODIMENTS

Advantages and features of the present invention and methods to achieve them will be elucidated from exemplary embodiments described below in detail with reference to the accompanying drawings. However, the present invention is not limited to exemplary embodiment disclosed herein but will be implemented in various forms. The exemplary embodiments is provided by way of example only so that a person of ordinary skilled in the art to fully understand the disclosures of the present invention and the scope of the present invention. Therefore, the present invention will be defined only by the scope of the appended claims. Meanwhile, terms used in the present invention are to explain exemplary embodiments rather than limiting the present invention. Also, when an element is referred to as being “connected to” another element, it can be directly connected to another element or be indirectly connected to another element with one or more intervening elements interposed therebetween. In the specification, a singular type may also be used as plural type unless stated specifically. Further, “comprises” and/or “comprising” used herein does not exclude the existence or addition of one or more other components.

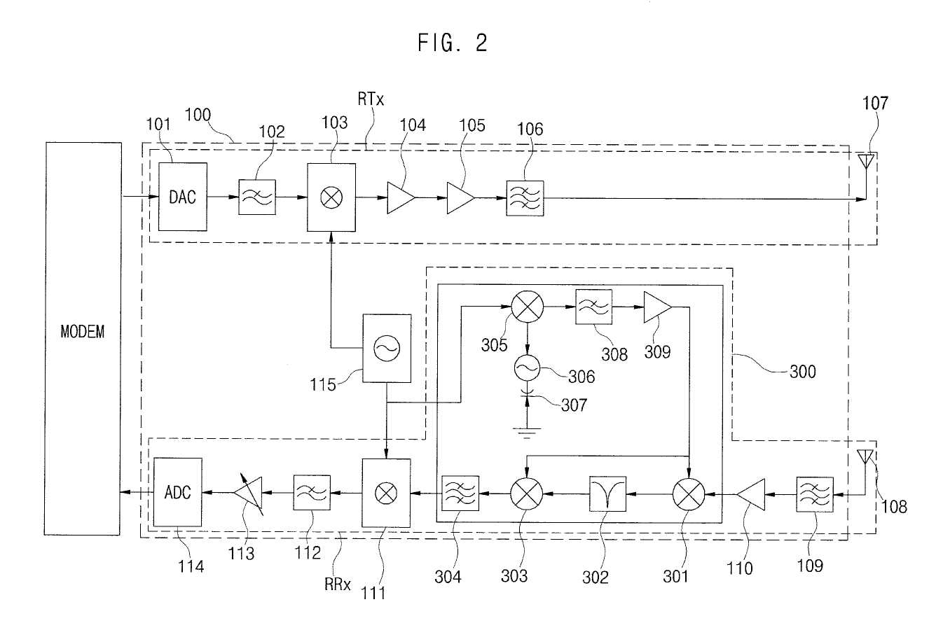

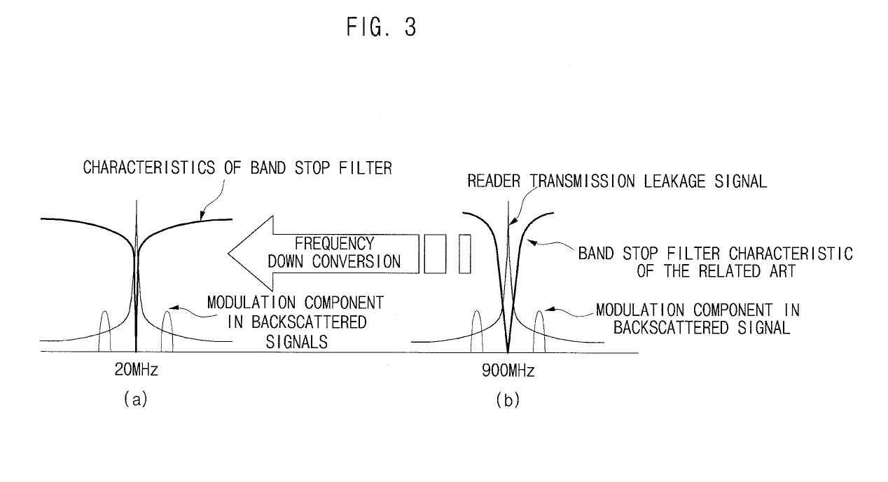

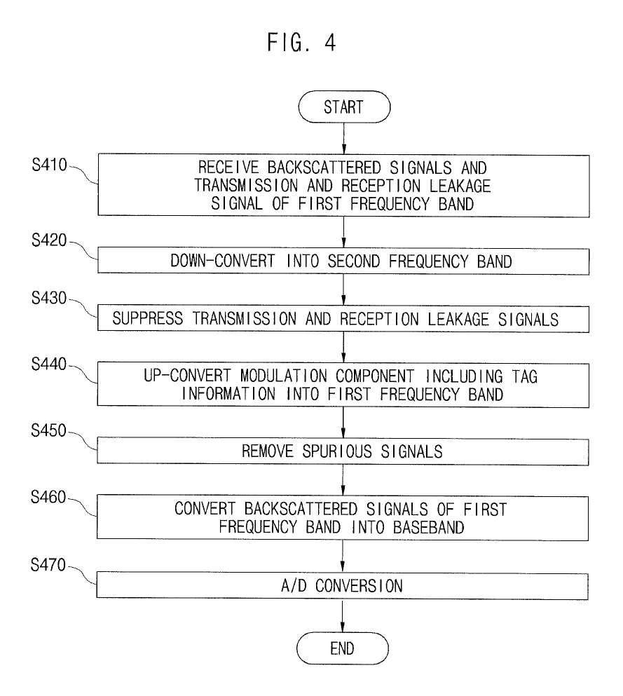

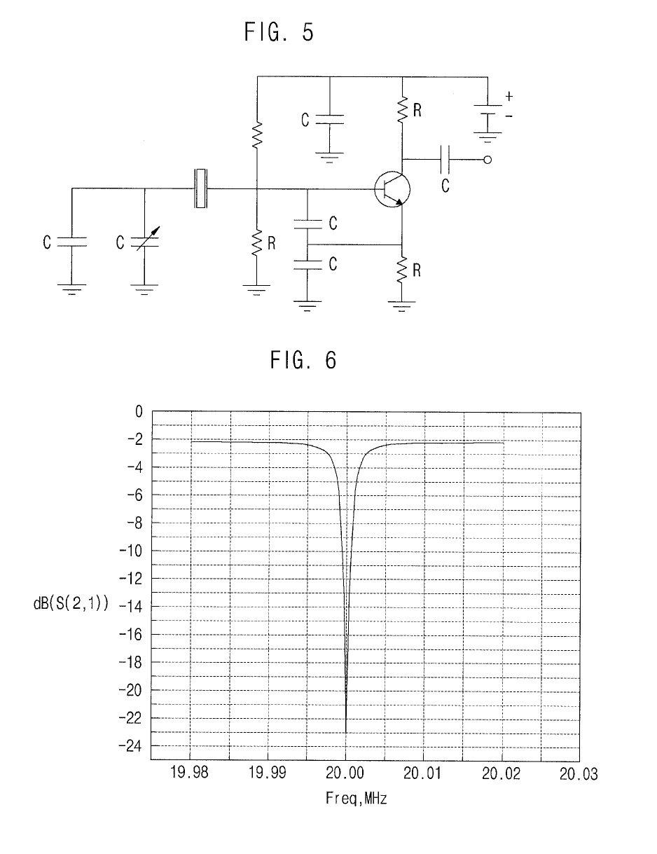

An RFID reader and a signal receiving method thereof according to exemplary embodiments of the present invention will be described with reference to FIGS. 2 to 6. FIG. 2 is a block diagram showing an RFID reader according to an exemplary embodiment of the present invention, FIG. 3 is a conceptual diagram for explaining an operation of the RFID reader according to the exemplary embodiment of the present invention, FIG. 4 is a flow chart showing a signal receiving method of the RFID reader according to the exemplary embodiment of the present invention, FIG. 5 is an exemplary circuit diagram of a quartz oscillator shown in FIG. 2, and FIG. 6 is a graph showing characteristics of a band stop filter shown in FIG. 2.

Referring first to FIG. 2, a reader receiver RRx includes a suppressing apparatus 300 that suppresses transmission leakage signals.

The operation of the reader receiver RRx will be described in detail with reference to FIGS. 3 and 4.

The reader receiver RRx receives backscattered signals of a first frequency band and transmission leakage signals of a first frequency band (S410). The backscattered signals in the first frequency band and the transmission leakage signals exist near 900 MHz, for example, as shown in a signal spectrum on the right side of illustration (b) of FIG. 3. The backscattered signals from the tag 200 are signals corresponding to signals transmitted from the reader transmitter TRx, which include backscattering carrier components backscattered from the transmission signals and modulation components including tag information. The backscattering carrier components may be signals backscattered by changing the receiving impedance of the tag 200 when the tag 200 receives the transmission signals of the reader transmitter TRx, for example, continuous wave signals. The signal spectrum may be the same as the spectrum of signals received by the reader receiver RRx in the existing 900 MHz UHF RFID system.

The reader receiver RRx down-converts the received backscattered signals and the transmission leakage signals from the first frequency band to a second frequency band lower than the first frequency band (S420). For example, the suppressing apparatus 300 of FIG. 3 down-converts the backscattered signals and the transmission leakage signals at the 900 MHz band into 20 MHz band in order to suppress the transmission leakage signals. It is technically difficult to suppress transmission leakage signals in the 900 MHz band using a band stop filter 302 since the modulation components including the tag information among the backscattered signals and the transmission leakage signals are very close to each other in the frequency spectrum. In other words, the frequency selection characteristic quality factor of the band stop filter 302 should reach several thousands to several tens of thousands in order to be able to suppress only the transmission leakage signals, as shown in the spectrum on the right side of illustration (b) of FIG. 3, which cannot be achieved. The frequency selection characteristic quality factor means a value obtained by dividing a resonance frequency by a 3 dB bandwidth.

Therefore, in the exemplary embodiment of the present invention, the suppressing apparatus 300 of the RFID reader down-converts the transmission leakage signals at the 900 MHz band into a frequency band (for example, 20 MHz) and suppresses them using the band stop filter 302 (S430), as shown in a spectrum on the left side of illustration (a) of FIG. 3. In order to selectively suppress the transmission leakage signals in the frequency band, the required central frequency of the band stop filter 302 is low and thus, the frequency selection characteristic quality factor has a value below several tens to several hundreds, which can be easily implemented. Therefore, the reader receiver RRx can extract only the modulation components including the tag information.

The suppressing apparatus 300 again up-converts the modulation components including the tag information into the first frequency band, for example, 900 MHz band (S440). Another example is that the modulation components may be converted into another frequency band higher than the second frequency band.

The reader receiver RRx removes spurious signals (S450), converts the backscattered signals in the first frequency band into a baseband (S460), and converts them into analog-to-digital signals (S470), which can in turn be output to a digital unit.

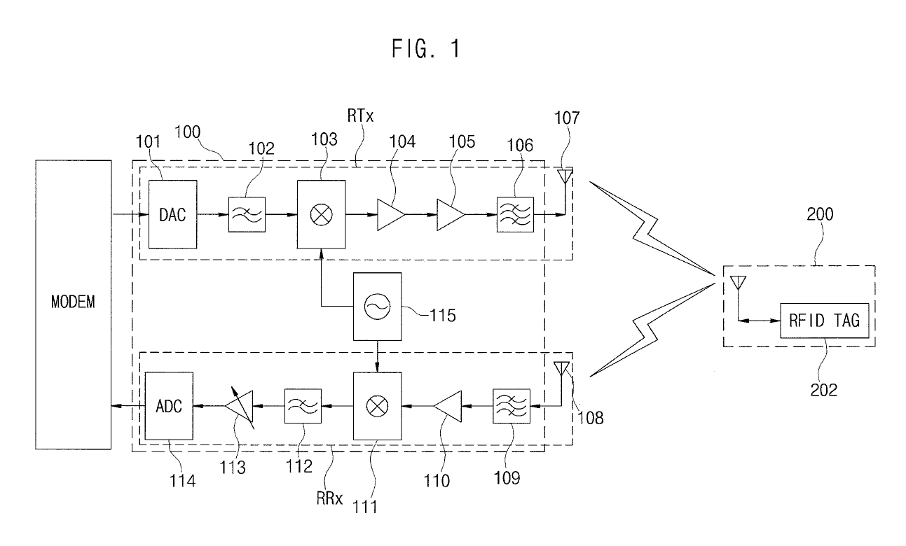

The RFID reader 100 will be described in more detail with reference to FIG. 2. However, components performing the same functions as components shown in FIG. 1 are denoted by the same reference numerals and therefore, the detailed description of the corresponding components will be omitted.

The reader receiver RRx includes the suppressing apparatus 300 that can suppress the transmission leakage signals, wherein the suppressing apparatus 300 may include a down frequency mixer 301, the band stop filter 302, and an up frequency mixer 303.

When receiving the backscattered signal and the transmission leakage signal from the passive tag through the receiving antenna 108, the down frequency mixer 301 down-converts the backscattered signal and the transmission leakage signal in the first frequency band into the second frequency band, as shown in FIG. 3.

The band stop filter 302 suppresses the transmission leakage signals among the down-converted signals and transmits only the modulation components among the backscattered signals from the tag as they are. Specifically, when the backscattered signal from the tag includes the backscattering carrier components which are backscattered from at least a part of the transmission signals and the modulation components including the tag information, the band stop filters 304 and 302 suppress the transmission leakage signal and the backscattering carrier components and transmits the modulation components including the tag information. Herein, it is preferable that the band stop filter 302 has the large frequency selection characteristic quality factor enough to have no effect on the modulation components including the tag information among the backscattered signals from the tag. The band stop filter 302 may be implemented as, for example, a quartz oscillator.

The up frequency mixer 303 again up-converts the signals passing through the band stop filter 302 into the first frequency band, for example, at 900 MHz UHF band. However, as described above, the present invention is not necessarily limited to recovering into the first frequency band.

Further, the filter 304 removes spurious signals generated during the frequency mixing process and then transfers the backscattered signals to a demodulator 111. The Spurious signal means the signal components out of the defined band, including unnecessary harmonic/subharmonic during the frequency mixing process.

Meanwhile, the modulation/demodulation frequency is a frequency used when modulating the command signals, that is, the transmission signals or demodulating the modulation components of the tag information and is generated by a modulation/demodulation frequency generator 115 (see FIGS. 1 and 2).

At this time, the down frequency mixer 301 and the up frequency mixer 303 can use the modulation/demodulation frequency to perform the down conversion and the up conversion of the frequency band, respectively.

In detail, the reader receiver RRx may further includes a band conversion frequency mixer 305, a quartz oscillator 306, a varactor diode 307, a filter 304, and an amplifier 309.

The band conversion frequency mixer 305 provides local signals so that the down frequency mixer 301 and the up frequency mixer 303 each performs the down conversion and the up conversion of the frequency band. For example, the band conversion frequency mixer 305 may mix the modulation/demodulation frequency generated by the modulation/demodulation frequency generator 115 with the resonance frequency of the quartz oscillator used in the band stop filter 302 to generate the local signals and may provide the local signals to the down frequency mixer 301 and the up frequency mixer 303. Herein, the local signals can be provided by removing noise by the filter 308 and amplifying the magnitude using the amplifier 309. The quartz oscillator 306 has a high frequency selection characteristic quality factor to obtain stable vibration and may further include the varactor diode 307 or a variable capacitor for fine frequency tuning. Although FIG. 2 separately shows the quartz oscillator 306 and the band stop filter 302, the quartz oscillator 306 can be commonly used to implement the band stop filter 302.

FIG. 5 shows an exemplary circuit of the quartz oscillator 306 of FIG. 2, which is an oscillator circuit using a general quartz oscillator. The quartz oscillator 306 shown in FIG. 5 is an oscillator circuit using a transistor and may be implemented by a CMOS logic IC.

FIG. 6 is a graph showing characteristics of the band stop filter 302 using the quartz oscillator. The transmission leakage signals corresponding to the intermediate frequency of the band stop filter 302 can be suppressed by the band stop filter 302.

While certain embodiments have been described above, it will be understood by those skilled in the art that the embodiments described can be modified into various forms without changing technical spirits or essential features. Accordingly, the embodiments described herein are provided by way of example only and should not be construed as being limited. While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An RFID reader, comprising:
a reader transmitter that transmits transmission signals; and
a reader receiver that down-converts backscattered signals of a tag in a first frequency band corresponding to the transmission signals and the transmission leakage signals leaked from the transmission signals in the first frequency band into a second frequency band lower than the first frequency band and selectively up-converts modulation components including tag information among the backscattered signals from the down-converted results into a third frequency band higher than the second frequency band.

2. The RFID reader according to claim 1, wherein the backscattered signals includes backscattering carrier components backscattered from at least a part of the transmission signals and the modulation components including the tag information, the RFID reader further comprising:
a down frequency mixer that down-converts the backscattered signals and the transmission leakage signals from the first frequency band into the second frequency band;
a band stop filter that suppresses the transmission leakage signals and the backscattering carrier components among the backscattered signals and the transmission leakage signals down-converted into the second frequency band and transmits the modulation components including the tag information; and
an up frequency mixer that up-converts signals received from the band stop filter into the third frequency band.

3. The RFID reader according to claim 2, further comprising:
a modulation/demodulation frequency generator that generates a modulation/demodulation frequency,
wherein the reader transmitter includes a modulator that modulates the transmission signals using the modulation/demodulation frequency; and
the reader receiver includes a demodulator that demodulates the modulation components in the third frequency band using the modulation/demodulation frequency.

4. The RFID reader according to claim 3, further comprising:
a band conversion frequency mixer that mixes a resonance frequency of a quartz oscillator with the modulation/demodulation frequency,
wherein the down frequency mixer and the up frequency mixer performs down conversion and up conversion, respectively, using the frequency generated by the band conversion frequency mixer.

5. The RFID reader according to claim 4, wherein the band stop filter includes:
the quartz oscillator; and
a variable capacitor or a varactor diode for tuning the resonance frequency of the quartz oscillator.

6. The RFID reader according to claim 2, wherein the reader receiver includes a filter that removes spurious signals generated during the up conversion process of the up frequency mixer.

7. A signal receiving method of an RFID reader, comprising:
receiving backscattered signals of a tag in a first frequency band corresponding to transmission signals and transmission leakage signals leaked from the transmission signals in the first frequency band;
down-converting the backscattered signals and the transmission leakage signals from the first frequency band into a second frequency band lower than the first frequency band; and
selectively up-converting modulation components including tag information among the backscattered signals from the down-converted results into a third frequency band higher than the second frequency band.

8. The signal receiving method according to claim 7, wherein the backscattered signals includes backscattering carrier components backscattered form at least a part of the transmission signals and modulation components including the tag information, the up-converting including:
suppressing the transmission leakage signals and the backscattering carrier components among the down-converted backscattered signals and transmission leakage signals; and
up-converting the modulation components including the tag information into the third frequency band.

9. The signal receiving method according to claim 8, further comprising:
demodulating the modulation components using a demodulation frequency.

10. The signal receiving method according to claim 9, further comprising:
generating a band conversion frequency using the demodulation frequency,
wherein the down-converting and the up-converting perform down conversion and up conversion, respectively, using the band conversion frequency.

11. The signal receiving method according to claim 7, wherein the up-converting includes removing spurious signals.

12. An RFID reader, comprising:
a down frequency mixer that down-converts backscattered signals of a tag in a first frequency band for transmission signals and transmission leakage signals leaked from the transmission signals in the first frequency band into a second frequency band lower than the first frequency band,
a band stop filter that suppresses the transmission leakage signals among the down-converted backscattered signals and transmission leakage signals; and
an up frequency mixer that up-converts signals input from the band stop filter into a third frequency band higher than the second frequency band.

13. The RFID reader according to claim 12, wherein the backscattered signals includes backscattering carrier components where at least a part of the transmission signals is backscattered and modulation components including the tag information, and
the band stop filter suppresses the transmission leakage signals and the backscattering carrier components and transmits the modulation components including the tag information.

14. The RFID reader according to claim 13, wherein the band stop filter includes:
a quartz oscillator; and
a variable capacitor or a varactor diode for tuning the frequency of the quartz oscillator.

15. The RFID reader according to claim 12, further comprising:
a filter that removes spurious signals generated during the up conversion process of the up frequency mixer.

16. The RFID reader according to claim 12, further comprising:
a modulation/demodulation generator that generates a modulation/demodulation frequency; and
a demodulator that demodulates the signals up-converted into the third frequency band using the modulation/demodulation frequency,
wherein the down frequency mixer and the up frequency mixer perform the down conversion and the up conversion, respectively, using the modulation/demodulation frequency.
